(19) United States
(12) Patent Application Publication
(10) Pub. No.: US 2010/0206920 A1
(43) Pub. Date: Aug. 19, 2010

(54) Wine glass holster and method of manufacture thereof

(76) Inventors: Stanley Rex Byrns, Canton, TX (US); Kimberly Anne Byrns, Canton, TX (US)

Correspondence Address: Justus Lapham, 201 S. Main Ste 6, Victoria, TX, 77901, US

(21) Appl. No.: 12/378,355

(22) Filed: Feb. 17, 2009

(51) Int. Cl. A45F 5/02; B23P 13/04

(52) U.S. Cl. 224/148.4; 29/557

(57) ABSTRACT

An apparatus for holding and carrying stemware and informational cards by attachment to personal clothing articles, or freely standing, and method of manufacture is described. When used as a wine glass holder the apparatus is connected to the person by attachment to various clothing articles by use of an extending hook. The apparatus comprises a base aperture that allows placement of the stem of a stemware glass into a base receptacle. The bowl or receptacle part of the stemware glasses rests solely onto the extending base sidearms. The base is attached perpendicularly to a hooking mechanism and is of a contiguous piece thereof. Furthermore, the hook attachment and upper base allow for the placement of a promotional or business card by a pinching action. When not in use as a wine glass holder, the apparatus stands up on a flat surface and may display a card or other indicia.

### CROSS REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

(1) Field of the Invention

The invention relates to an apparatus for the placement of stemware glasses into a releasable capturing receptacle. In particular this invention directs itself to a stemware attachment system, which provides means to fixedly couple the mounting receptacle through any aperture of a clothing article. The device also relates to novelty devices which hold cards or other paper materials, i.e. business cards, brochures, etc.

(2) Description of Related Art

Devices that are conceived to hang and secure items to the human body by means of attachment to clothing articles are well-known in the art, U.S. Pat. Nos. 3,146,925; 3,307,754; 4,306,434; 4,658,479; 5,540,367; 5,893,497; 5,946,839, 5,983,686; 6,062,521; 6,427,293; 6,606,769; 6,626,336; 2004/0124218A1.

Liquid receptacle attachment systems are well-known in the art. The best known prior art known to the Applicant include U.S. Pat. Nos. 4,606,523; 4,708,273; 4,634,089; 4,749,112; 4,858,869; 4,961,555; 4,993,611; 5,249,770; 5,913,463; 5,944,238; and 7,284,737.

In addition, card and indicia holding systems are well known in the prior art. Relevant examples can be found at U.S. Pat. Nos. 7,036,778; 7,240,802 and 6,799,390.

The majorities of these liquid receptacle attachment systems, however, describe an extending base onto which rests the glass itself, as the supporting mechanism or stand for the glass. The side wings of the apparatus provide a stability and rigid support to the glass to keep it escaping from the mechanism by means of an increased friction between the glass and the support, as well as an encirclement of the glass by the apparatus itself.

That prior art which does describe bottomless holders, i.e. holders in which the sidearms provide the sole means of supporting a glass, are specifically designed for stemware glasses, in which a bowl or receptacle sits on top of a stem; the stem of which rests upon a base. The devices have attachment means which generally lie on the same plane of the sidearms themselves.

### BRIEF SUMMARY OF THE INVENTION

The apparatus overcomes problems of prior art in that the drop down placement of the glass is resolved by the open aperture system. The stem may be introduced at any point along its axial length into the extending sidearms of the apparatus. At the point at which contact is made it can be felt by the user as it makes contact with the upper portion of the apparatus, at that point it can be safely and easily slid down by the user into the base. Instead of a supporting base to hold the glass in place, the force of gravity is used as the bowl of the stemware rests on the curved sidearms. These sidearms extend perpendicularly from a hook, which may be easily inserted into an article of clothing such as a belt loop.

One of the significant existing problems with all stemware holders it that they are designed to carry a combination of existing receptacles or bowls. Due to the structural shape of a large circular object (the bowl) sitting on top of a pinnacle (the stem) a wobbly support structure is introduced. This has the effect of introducing an oscillation wave effect into any liquid present when the glassware itself is moved as a whole. Current stemware holders contribute to the oscillation problem in that they allow for free movement of the uppermost portion of the bowl or receptacle; the support structure itself maximizes oscillation in that the fixed point of the holder/stemware is situated at the most wave inducing point of the entire structure, the center.

The current device overcomes this problem by introducing a fixed curve along the entire bowl portion. The stemware once introduced into the holster thus becomes locked into a fixed position, lateral oscillations of introduced by top/bottom counter motions are thus reduced. While motion of the person wearing the object may still contribute to oscillations, they are greatly reduced by the holster.

Also, the hook potion of the wine glass holster, is fixed mostly upon a top/down vertical axis, but due to the curved portion of the upper device significant stability on a horizontal plane is introduced. The current embodiment covers around 25 percent of the horizontal plane of the curved bowl, enough to substantially diminish right-left oscillations. In addition the upward stroke of the sidearms, contribute to a wrapping around the wineglass bowl, to a 75 percent degree. This bottom bowl wraparound, combined with the upper portion hook, provides a great deal of side to side wobble prevention. Again movement of the wearer may contribute to a wave effect but this designed is significant over current wine holders in that further oscillations of the wine glass interacting with the holder itself are substantially diminished.

Wine tasting events in particular have unique conditions and needs. Currently, the main devices used is the well known prior art of the wine necklace. In this apparatus the wine glass is inserted into a chain or string by various apparatuses which prevent the wine glass from slipping through. It has two drawbacks: 1, it limits the placement of the wineglass to a particular location i.e. the neck, and 2 it is difficult to rapidly place and remove the wineglass. Both hands are required to do this, which negates partially the whole purpose of the hand freeing device of the wine necklace. In addition wine tasting events are information rich, and require labeling and methods of identification of various wines. Current liquid holders have no ability to do this, and while it is a well known doctrine that extraneous aggregation do not disclose sufficient patentability, the current device incorporates a card holder in a unique, intrinsic way by using the backside of the hooking mechanism as one of the necessary two supports of the card holding portion of the device.

Furthermore, the card holding portion of the device provides an additional secondary use by itself, and aside of the wine glass holding means. By its ability to stand upright upon a surface, a card or paper can be held up in such a way that it provides a unique means of displaying information.

### BRIEF DESCRIPTION OF THE SEVERAL VIEWS OF THE DRAWINGS

FIG. 1 is a perspective view of the wine glass holster.

FIG. 2 is a front view of the wine glass holster.

FIG. 3 is a side view of the wine glass holster.

### DETAILED DESCRIPTION OF THE INVENTION

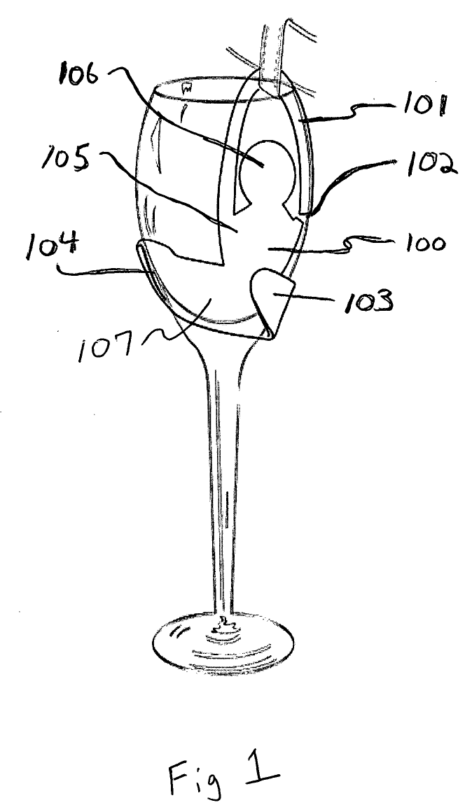

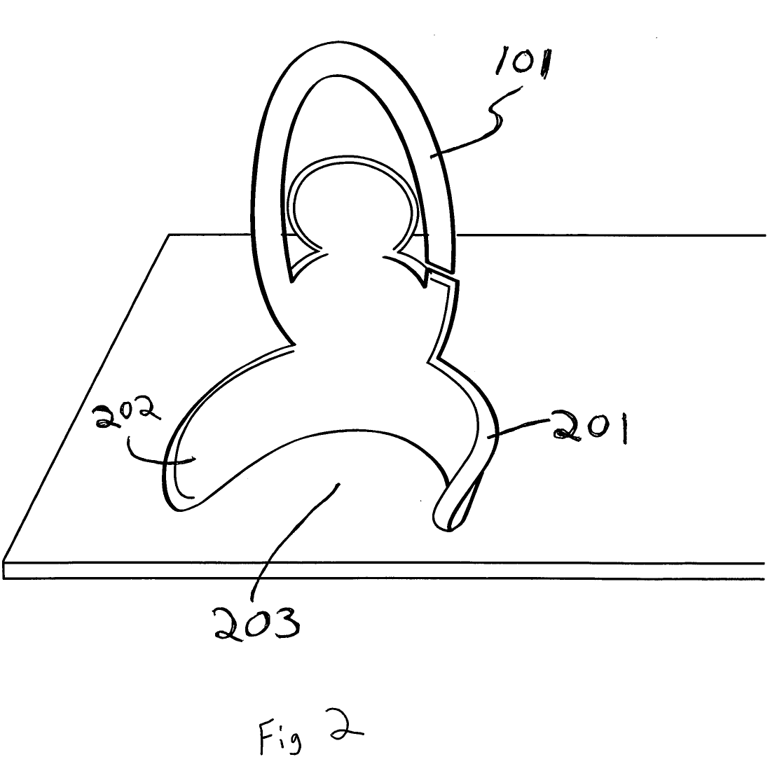

Referring to FIG. 1 there is shown wine glass holster system 100, for releasably capturing and supporting a wine glass. 101 shows an elongated semicircular hooking mechanism. 102 is an opening which by means of the generally horizontal movement of the most distal portion of the hook, allows for insertion into another hole, or loop. 103 and 104 together provide the base mechanism for support of the wine glass. 103 and 104 are designed to provide a rigid support since the glass itself is held within the semi arc described by 103 and 104 by means of gravity and friction. 107 describes the arc which is created by 103 and 104. The arc is a descending nature, with a smaller circumference at the base than at the top. The particular nature of the material is rigid enough to support a full wineglass. 105 extends up into the aperture of the hooking mechanism, and extends up out of the base. On top of 105 is 106, which is the front portion of the bifurcated, pressure holding or pinching mechanism of the card holder

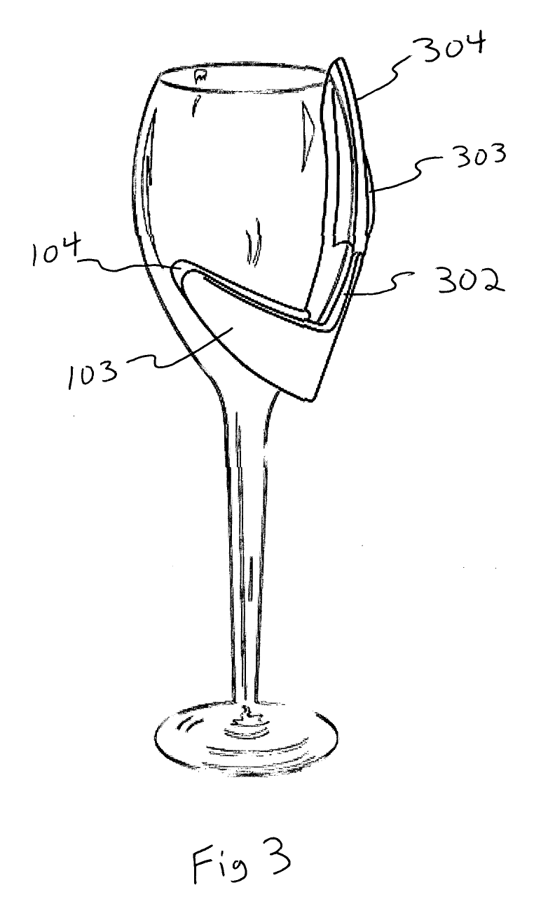

Referring to FIG. 2. shows the frontal view of the mechanism showing it as it stands upon a flat surface. 202 and 201 are the extending sidearms of the device. The bottommost aperture 203; created by the distance between sidearms 201 and 202 can vary in width, but in the present embodiment is slightly wider than the largest portion described by the hook 101 mechanism.

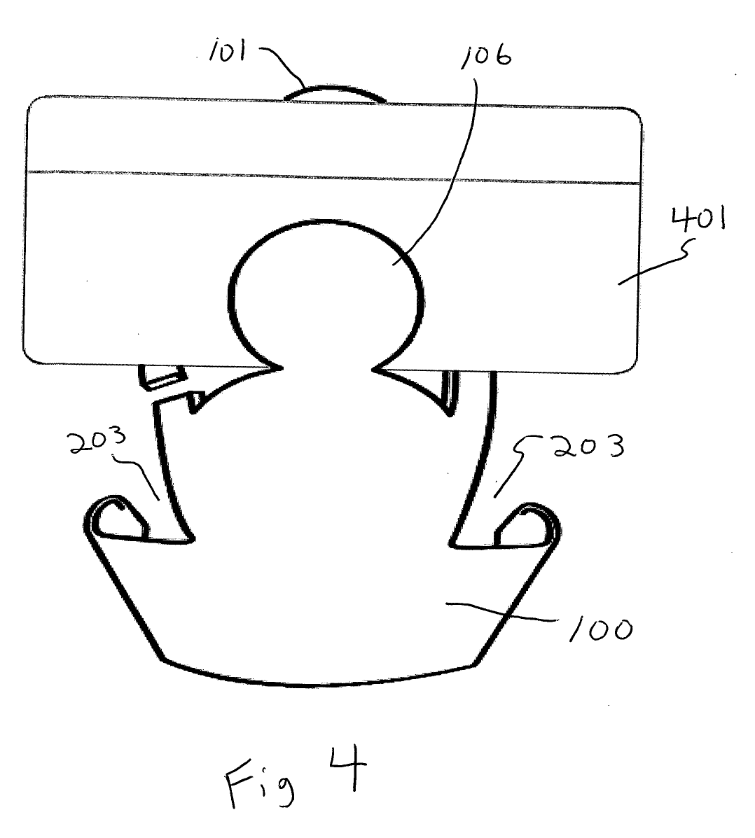

Referring to FIG. 3 is the side view of the apparatus, 302 is the extending base. The hook mechanism 304 extending up and out of the base 302 extends general 20 degrees forward over the base 302 mechanism. The curved portions of the sidearms 103 and 104 allow for stability by providing a slight rocking motion, so that the device can readily stand up on a flat surface by its own accord. The central and front portion of the card holding mechanism 303 will have a degree of forward extension slightly smaller than that of the extending hooking mechanism 304. This forward extension of the hooking mechanism is to provide two functions: 1, to provide stability to the device so that it may stand upright upon a flat surface and not fall backwards, and 2, to allow for easy reading of the card or paper to be placed within the front portion of the card device 303 and the back portion of the card device 304 from an angle at which it would normally be read by a person standing or sitting at a normal angle higher than which the apparatus is placed.

Referring to FIG. 4, is a back view of the apparatus 100, showings it use as a card holder. In the current embodiment, the device will be placed upon a flat surface, turned around so that the aperture 203 is away from the viewer, and a card 401 is placed in front of 101 distally; and behind section 106 proximately, in relation to the intended viewer. The preferred embodiment shows a circular front, proximate portion, but this may take a variety of shapes, such as square, triangle, rectangle, or trademarked design or particular use as needed by the end user.

One of the main attributes of the device is the extra stability and wave prevention provided by a unique fit of the glass into extra surface covering sidearms, and a hook which is all encompassing of the top part of the glass itself. This is achieved by the current preferred method of manufacture.

The method or manufacture of a space specific wine glass holder is described herein and is applicable to one skilled in the art of laser engraving and cutting. A solid piece of acrylic 32 inches by 20 inches, and of a depth sufficient enough to provide support but not too deep to prevent easy molding, in this instance ¼ of an inch of depth forms the basis of manufacture of multiple sets of wine glass holders.

The initial shape of the wineglass holder is designed by a computer program into a 2 dimensional grid. The efficient process is using a vector drawing program. A two-dimensional template is thus created and further developments may be introduced such as the specific shape of the card holder back end portion of the hooking mechanism, or the diameter of the hooking mechanism, or additional detail work on any portion of the design aspect of the wine glass holster. Also at this point, engravings or lettering may be designed to be performed on the front or back of the device.

The algorithm thus created, it may be sent by any one of commonly available means to the laser engraver. The current method uses the Pinnacle Laser ZX, a 40 watt laser. The algorithm is exported via a standard USB port into the laser engraver.

The cutting and engraving are made in one path, and two dimensional shapes are created. In the current production method, 36 two dimensional shapes are created. They are in general to fit a large variety of wine glass types and makes, but at this point are not glass specific.

The next stage is to be performed in a near simultaneous process. The two dimensional flat shapes are heated in a standard oven at 275 degrees Fahrenheit, this generally takes six minutes.

The two dimensional flat shapes of the holsters are then removed and held individually in a gloved hand, a glass is selected, and the plastic shape is molded around the glass in a slightly upward motion. The bottom sidearms are thus shaped around the bottom portion of the receptacle, slight downward pressure is applied to the hooking mechanism to form a complete fit to the upper portion of the glass.

Thus shaped, the glass and holster are immediately cooled as a single unit. This is done by a quick immersion into room temperature water. This wine glass and holster are held in immersion for around ten seconds. The now three dimensional shapes are then removed from the glass. The finished product is then allowed to dry.

What is claimed is:

1. An apparatus for attaching a wineglass to an object, comprising externally curving sidearms attached to the lower portion of the apparatus such that said sidearms are sufficient to hold a bowl of a wineglass by means of gravity and friction, and an upper portion consisting of a hooking mechanism allowing for attachment of the apparatus to an article of clothing.

2. The apparatus of claim 1 wherein the hooking mechanism is combined with an internal intrusion from the lower portion such that combined, said combination allows for the placement by pinching means of a card or paper.

3. The apparatus of claim 1 or 2 in which the hooking means are curved into an angle extending forward above the base sidearms, sufficient so that the apparatus will have enough stability to stand upon its own accord.

4. The apparatus of claim 1 or 2 in which the hooking means are curved into an angle extending forward above the base sidearms, sufficient so that the hooking means make continuous contact with the corresponding portion of particular wine glass

5. The apparatus of claim 1 or 2 in which the base sidearms provide the ability to lay the device upright and remain in a standing position.

6. The apparatus of claim 1 or 2 in which said combined hooking and internal intrusion means are in an angle sufficient so that said apparatus may stand upright upon a flat surface when holding a card or paper, and that said card or paper may be easily viewed by persons standing or sitting above said apparatus.

7. A method of producing a wine glass holster, which comprises the steps of
(a) designing a two dimensional structure by the creation of a pattern;
(b) perforating the two dimensional structure;
(c) heating the two dimensional structure so that it becomes pliable;
(d) transforming the two dimensional structure into a space specific three dimensional shape, by applying it with sufficient force around a particular wine glass;
(e) cooling the object sufficiently and in such a manner that it retains its transformed shape.
